(19) United States
(12) Patent Application Publication
(10) Pub. No.: US 2020/0171780 A1
(43) Pub. Date: Jun. 4, 2020

(54) COMPOSITE PANEL MADE OF MULTIWALL POLYCARBONATE SHEET COVERED BY LAMINATE LAYER

(71) Applicant: Furio Bianchi, Palazzo Pignano (CR) (IT)

(72) Inventor: Furio Bianchi, Palazzo Pignano (CR) (IT)

(21) Appl. No.: 16/629,258

(22) PCT Filed: Jul. 18, 2018
(86) PCT No.: PCT/IB2018/055317

§ 371 Date: Jan. 7, 2020

(30) Foreign Application Priority Data
Jul. 19, 2017 (IT) 102017000081708

(51) Int. Cl. B32B 3/12; B32B 27/36; B32B 7/12; B32B 15/09; B32B 27/08

(52) U.S. Cl. CPC B32B 3/12; B32B 27/365; B32B 7/12; B32B 15/09; B32B 2605/08; B32B 2605/003; B32B 2605/12; B32B 2605/18; B32B 27/08

(57) ABSTRACT

A structural type panel suitable for the production of furnishings and fittings for interiors and exteriors, for vehicles. A pair of substantially flat, opposing and parallel laminated-sheet surfaces form the outer longitudinal walls of the panel, and at least one multiwall-polycarbonate reinforcement structure is enclosed between the two surfaces and includes a plurality of internal walls defining a plurality of respective channels or cells. The internal walls and the respective channels or cells are oriented longitudinally and along a parallel direction to the development planes of the two surfaces, with at least a longitudinal portion of one or more walls arranged in contact with at least one of the two surfaces. Each of the two surfaces is coupled to the multiwall reinforcing structure by a bonding layer deposited between the multi wall reinforcing structure and the fixing side of each of the two surfaces, which layer substantially extends throughout the surfaces.

The present invention relates to a composite panel made of multiwall polycarbonate sheet covered by a laminated layer. More specifically, the present invention relates to a multiwall-polycarbonate laminated panel which has excellent aesthetic characteristics, lightness, rigidity, mechanical resistance to deformation and abrasion, as well as resistance to moisture, water, immersion and fire. The composite panel is a structural type panel particularly suitable for the production of furnishings and fittings for interiors and exteriors, for vehicles used in the terrestrial, maritime and aerospace sector, but also for the construction of artifacts, walls and structures.

Currently, the multiwall polycarbonate panels, for their characteristics of transparency, lightness, impermeability and water resistance, are used in the building industry for the realization of roofing, sound-absorbing and/or insulating walls and floral greenhouses instead of windows. On the contrary, these panels are not typically used either for the creation of real furnishings, or for the construction of self-supporting walls. A multiwall polycarbonate sheet, in fact, does not possess adequate aesthetic and mechanical resistance characteristics for these uses.

For example, document WO 99/62295 A1 discloses a sound-absorbing panel with certain acoustic and frequency response characteristics. The overall thickness of this panel is particularly reduced, being of about 6 mm. Moreover, the honeycomb cells direction of the panel according document WO 99/62295 A1 would appear to be arranged perpendicular to the outer surfaces of the panel, as shown for example in FIGS. 1-3 of this document.

The production process of the sound-absorbing panel according to document WO 99/62295 A1 starts from a honeycomb structure formed by few cells separated by partitions, with some of the walls deformed and welded together, by means of a heat and pressure process. The honeycomb structure can be obtained by arranging, side by side, some tubes in a matrix. The tubes are preferably packaged. More precisely, each tube inside the body of the matrix is surrounded by some of other tubes. This results in a honeycomb structure formed by large cells, defined by the tubes, and small cells, constituted by the spaces between the tubes themselves. The tubes can then be heated under pressure, so that their respective ends can be deformed. This deformation is exclusively dedicated to obtaining high sound-absorbing qualities of the panel.

In addition, the sound-absorbing panel according to document WO 99/62295 A1 is provided with a sound-absorbing film interposed between the honeycomb structure and a surface coating film. The surface coating film may consist of a glass fiber impregnated with polycarbonate. Once again, the function of this coating film is to improve the sound-absorbing qualities of the aesthetic panel rather than to guarantee structural and/or aesthetic panel performances.

Document EP 1774128 A1 discloses a sound-absorbing and heat-insulating panel, internally provided with a structure with open cells and large empty spaces. In fact, this panel can be adapted for the realization of windows. Moreover, also the cells of the panel according to document EP 1774128 A1 are arranged perpendicular to the outer surfaces of the panel, as shown for example in FIGS. 17 and 8 of this document.

In wider terms, the perpendicular disposition of the internal cells in the panel reduce the mechanical strength of the outer surfaces of the panel. The panel surfaces are in fact provided with very robust portions, obtained at the perimeter that forms the walls of the internal cells, but also of much weaker portions, obtained at the internal cavities of the cells themselves. Furthermore, in the event of a collision, the outer surfaces of the panel could be damaged or broken at the respective weak portions.

The perpendicular arrangement of the internal cells of a panel makes it difficult to glue the external surfaces on the cells matrix. The glue layer, in fact, can only be applied on the thin perimeter that forms the cell-walls, while at the cell-cavities there is no gluing effect. Therefore, this drawback entails a reduction of mechanical strength of the panel.

An object of the present invention is therefore to provide a multiwall polycarbonate laminated composite panel which has higher mechanical and structural strength characteristics than similar panels according to the prior art.

Another object of the present invention is to provide a multiwall polycarbonate laminated composite panel which is particularly simple to assemble.

These and other objects are achieved by providing a multiwall polycarbonate laminated composite panel according to the technical teachings of the appended claims.

Further characteristics and advantages of the invention will become clear from the description of some preferred but not exclusive embodiments of the s multiwall polycarbonate laminated composite panel, illustrated by way of example and therefore not limiting in the attached drawings, in which:

FIG. 1 is a cross-sectional view of a first embodiment of the panel according to the invention;

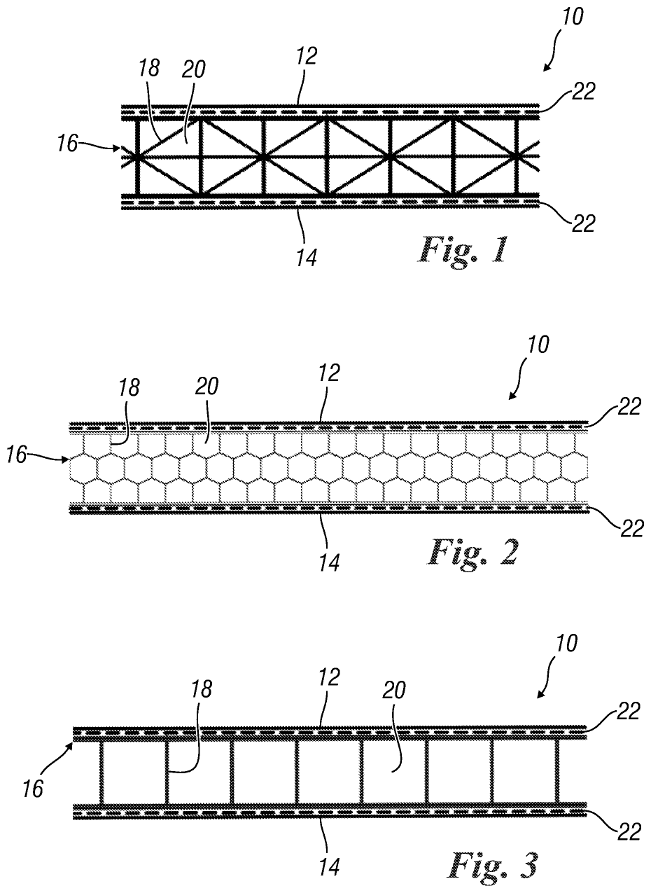

FIG. 2 is a cross-sectional view of a second embodiment of the panel according to the invention;

FIG. 3 is a cross-sectional view of a third embodiment of the panel according to the invention;

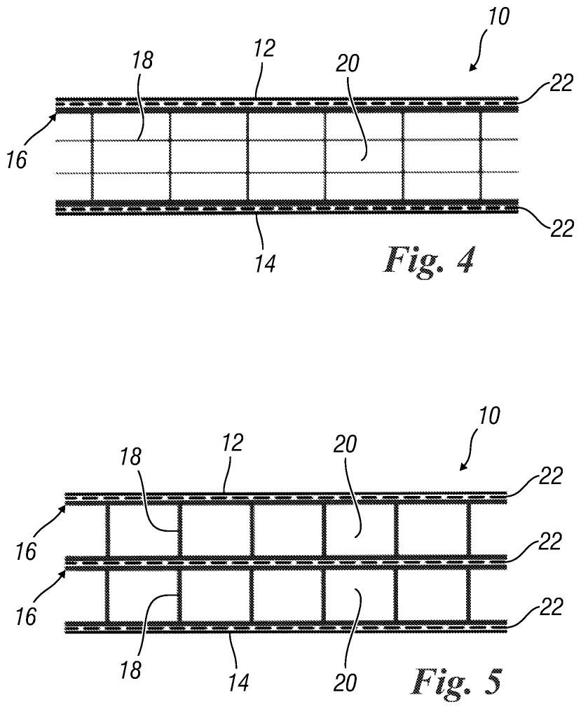

FIG. 4 is a cross-sectional view of a fourth embodiment of the panel according to the invention;

FIG. 5 is a cross-sectional view of a fifth embodiment of the panel according to the invention; and

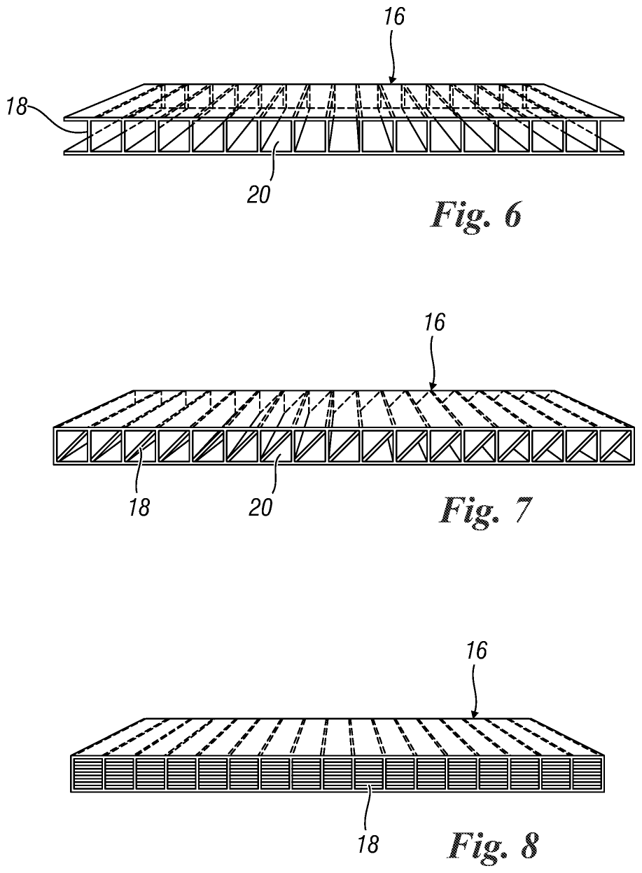

FIGS. 6, 7 and 8 show, in a perspective view, some multiwall polycarbonate core structure usable in a panel according to the invention, with variable thicknesses and with different structures of the respective cells.

With reference to the aforementioned figures, some preferred embodiments of the laminated multiwall polycarbonate laminated composite panel according to the present invention are shown. The panel is indicated as a whole with reference numeral 10.

The panel 10 is designed for the construction of furnishings and fittings, for vehicles used in the terrestrial, maritime and aerospace sectors and for the construction of artefacts, walls and structures, for indoor and outdoor use. The panel 10 comprises a pair of laminated-sheet surfaces 12, 14, which are substantially flat, opposed and parallel and furthermore they form the outer longitudinal walls of the same panel 10.

The panel 10 further comprises at least one multiwall-polycarbonate reinforcement structure 16, which is enclosed between the two laminated-sheet surfaces 12, 14 and is provided with a plurality of internal walls 18 which define a plurality of respective channels or cells 20 with longitudinal extension. In other words, the internal walls 18 and the respective channels or cells 20 are respectively oriented longitudinally and parallel to the development planes direction of the two laminated-sheet surfaces 12, 14, such that at least a longitudinal portion of one or more internal walls 18 is placed in contact with almost one of the two laminated-sheet surfaces 12, 14.

It is specified that, in the present context, “longitudinal direction” means a direction that is parallel to the development planes of the outer walls 12, 14 of the panel 10, or a direction that lies on one of said development planes. “Cross section” means a section that is perpendicular to the development planes of the outer walls 12, 14 of the panel 10. “Laminated sheet” means a thin wall obtained by a plastic or metal lamination process. Finally, by “multiwall reinforcing structure” we mean an internally hollow structure, whose cavities consist of a plurality of channels or cells.

The multiwall-polycarbonate reinforcement structure 16 can be simple or reinforced, with a variable thickness from 3 mm to a plurality of centimeters, even though with channels or cells 20 always longitudinal and parallel to the two laminated-sheet surfaces 12, 14 of panel 10. The multiwall-polycarbonate reinforcement structure 16 may furthermore be single or may comprise two or more mutually coupled multiwall-polycarbonate reinforcement structures 16.

The sectional shape of each channel or cell 20 can vary to meet specific requirements. Moreover, one or more extrusion layers may be provided to realize the multiwall-polycarbonate reinforcement structure 16, as shown for example in FIGS. 6, 7 and 8. Each multiwall-polycarbonate reinforcement structure 16 can also be made by a linear or curved honeycomb-polycarbonate panel.

According to a first embodiment of the panel 10, as shown in FIG. 1, the internal walls 18 of the multiwall-polycarbonate reinforcement structure 16 can be mutually connected to form a plurality of walls 18 that are intersected in a X-shaped way in the cross-section of the same panel 10. This plurality of walls 18 therefore encloses respective channels or cells 20 in a triangular-bases prismatic structure.

According to a second embodiment of the panel 10, as shown in FIG. 2, the internal walls 18 of the multiwall-polycarbonate reinforcement structure 16 can be mutually connected to form a plurality of walls 18 that are intersected to form a honeycomb assembly in the cross-section of the same panel 10. This plurality of walls 18 therefore encloses respective channels or cells 20 in a hexagonal-bases prismatic structure.

According to a third and a fourth embodiment of panel 10, as shown respectively in FIGS. 3 and 4, the internal walls 18 of the multiwall-polycarbonate reinforcement structure 16 can be mutually connected to form a plurality of walls 18 with a square (FIG. 3) or rectangular (FIG. 4) shape in the cross-section of the same panel 10. This plurality of walls 18 therefore encloses respective prism-shaped channels or cells 20 with respectively square/rectangular-bases prismatic structure.

In wider terms, the internal walls 18 of the multiwall-polycarbonate reinforcement structure 16 can be mutually connected to form a plurality of walls 18 that are intersected with any geometric shape in the cross-section of the same panel 10. This plurality of walls 18 can therefore enclose respective prism-shaped channels or cells 20 with bases constituted by a generic closed polygon.

Each one of the two laminated-sheet surfaces 12, 14 of the panel 10 is coupled to the multiwall-polycarbonate reinforcement structure 16 by a bonding layer 22 which is deposited between the multiwall-polycarbonate reinforcement structure 16 and the fixing side of each one of the two laminated-sheet surfaces 12, 14. In order to guarantee an adequate mechanical strength of the panel 10, the bonding layer 22 substantially extends throughout the whole area of each of the two laminated-sheet surfaces 12, 14 of the panel 10.

In order to obtain a panel 10 with greater mechanical strength or different or increased thickness, it is possible to couple two or more multiwall-polycarbonate reinforcement structures 16 by means of a bonding layer 22, and subsequently to couple the outer walls 12, 14 using a further bonding layer 22, as shown for example in FIG. 5.

Also one or more of the external transverse walls of panel 10 can be at least partially coated with respective laminated sheets, in order to hide and protect the internal multiwall-polycarbonate reinforcement structure 16. Preferably, these laminate sheets have characteristics identical to those of the two longitudinal surfaces 12, 14 or, in other words, are made of the same material as that of the longitudinal surfaces 12, 14.

The novelty concerning the panel 10 consists in a laminate processing of the multiwall-polycarbonate reinforcement structure 16, by means of a direct application of a laminate layer 12, 14 for each side. Each sheet of laminate 12, 14 may preferably have a thickness equal to or greater than 0.4 mm. Each sheer of s laminate 12, 14 can be made of a plastic or metal material, in order of give to panel 10 qualities of lightness and good looks in an infinite variety of finishes, colors and designs, and even a high value of mechanical resistance to deformation. Added value about exceptional hydro-resistance, lightness and surprising mechanical resistance to deformation, abrasion and fire, is particularly noticeable when panel 10 is used in standard thicknesses for furniture, included between 13 mm and 20 mm, and coupled with sheets of laminate with a thickness included between 0.7 mm and 1.2 mm, for the realization of furniture and fittings, saving more than 60% of weight if compared to traditional chipboard or wood multilayer panels of equal thickness.

The plastic material used for manufacturing each laminate sheet 12, 14 can preferably but not exclusively be made up of high pressure laminates (HPL), continuous pressure laminates (CPL), continuous high-pressure laminates (CHPL), vertical flame retardant post-forming (VFP), melamine faced chipboard (MFC) or acrylonitrile-butadiene-styrene (ABS).

For coupling the multiwall-polycarbonate reinforcement structure 16 to laminate layer of each laminated-sheet surface 12, 14, various industrial and artisanal gluing techniques can be used, as well as suitable adhesives, for example based on polychloroprene, silicone, polyurethane, etc. Bi-adhesive films, heat-sealing or a thermo-bonding process can be used too.

The bonding layer 22 between the multiwall-polycarbonate reinforcement structure 16 and each laminated-sheet surface 12, 14 could be obtained even by a chemical or thermochemical surface deposition process of each laminated-sheet surface 12, 14 directly on the multiwall-polycarbonate reinforcement structure 16. In addition, the bonding layer 22 may also be obtained by a chemical or thermochemical combined extrusion process of the multiwall-polycarbonate reinforcement structure 16 directly on the two laminated-sheet surfaces 12, 14. In any case, regardless of the type of coupling between the multiwall-polycarbonate reinforcement structure 16 and each laminated-sheet surface 12, 14 covered by laminate sheet, it is advisable to apply a transverse compression load over the entire longitudinal surface of panel 10 during the coupling process, so as to avoid detachment points between the multiwall-polycarbonate reinforcement structure 16 and laminate layer of each laminated-sheet surface 12, 14.

It is thus seen that the composite panel with multiwall polycarbonate core covered by laminate layer according to the present invention achieves the previously highlighted objects. The parallelism of the cells, with reference to the longitudinal surfaces of the panel, makes it possible to obtain this panel by extrusion, without inducing any deformation in the panel structure and any reduction of its mechanical strength characteristics.

In addition, the parallelism of the cells with reference to the longitudinal surfaces of the panel gives these longitudinal surfaces considerable mechanical strength against frontal impacts and mechanical stresses by concentrated loads on the surfaces of the same panel. As a matter of fact, the longitudinal laminate surfaces find additional and uniform reinforcement walls, made up by internal walls of polycarbonate support structure, along their whole extension.

The longitudinal direction of the internal walls of the alveolar support structure, on which are integrated the longitudinal surfaces of the panel, allows an excellent and strong gluing of these longitudinal surfaces onto the respective support, which could not be achieved in the panels with cells perpendicularly arranged in referring to the face of the same panel.

Finally, for the construction of the multiwall polycarbonate reinforcement structure, which acts as a support for the laminate surfaces of the panel and which is covered by such laminate surfaces, it is not necessary to use a raw material (granular or “granulated” polymer) of great quality, as is the case with polycarbonate panels that are normally produced and required for their transparency feature. On the contrary, for the extrusion of the polycarbonate honeycomb reinforcement structure it is possible to use processing waste and a very low quality granulate, therefore with a very low cost of raw material or even free from a recycling work plan, and it is even possible to earn money for disposal. This constitutes a great advantage, in terms of environmental impact of the panel according to the invention.

1. Composite structural panel (10) for the production of furnishings and fittings for interiors and exteriors, for vehicles used in the terrestrial, maritime and aerospace sectors and for the construction of artefacts, walls and structures, said panel (10) comprising:
a pair of laminated-sheet surfaces (12, 14), said two surfaces (12, 14) being substantially flat, opposite and parallel, said two surfaces (12, 14) forming the outer longitudinal walls of the panel (10);
at least one multiwall-polycarbonate reinforcement structure (16), said multiwall-polycarbonate reinforcement structure (16) being enclosed between said two surfaces (12, 14) and being provided with a plurality of internal walls (18) which define a plurality of respective channels or cells (20) with longitudinal extension,
wherein said plurality of internal walls (18) and said plurality of respective channels or cells (20) are respectively oriented longitudinally and along a parallel direction with respect to the development planes of said two surfaces (12, 14), so that at least a longitudinal portion of one or more of said internal walls (18) is arranged in contact with at least one of said two surfaces (12, 14), wherein each of said two surfaces (12, 14) is coupled to said multiwall-polycarbonate reinforcement structure (16) by a bonding layer (22) which is deposited between said multiwall-polycarbonate reinforcement structure (16) and the fixing side of each of said two surfaces (12, 14), and wherein said bonding layer (22) substantially extends throughout the whole area of each of the two surfaces (12, 14).

2. Composite structural panel (10) according to claim 1, characterized in that the internal walls (18) of said multiwall-polycarbonate reinforcement structure (16) are mutually connected to form a plurality of walls (18) that are intersected in a X-shaped way in the cross-section of said panel (10), said plurality of walls (18) enclosing respective channels or cells (20) in a triangular-bases prismatic structure.

3. Composite structural panel (10) according to claim 1, characterized in that the internal walls (18) of said multiwall-polycarbonate reinforcement structure (16) are mutually connected to form a plurality of walls (18) that are intersected to form a honeycomb assembly in the cross-section of said panel (10), said plurality of walls (18) enclosing respective channels or cells (20) in a hexagonal--bases prismatic structure.

4. Composite structural panel (10) according to claim 1, characterized in that the internal walls (18) of said multiwall-polycarbonate reinforcement structure (16) are mutually connected to form a plurality of walls (18) with a square or rectangular shape in the cross-section of said panel (10), said plurality of walls (18) enclosing respective prism-shaped channels or cells (20) with respectively square/rectangular-bases prismatic structure.

5. Composite structural panel (10) according to claim 1, characterized in that the internal walls (18) of said multiwall-polycarbonate reinforcement structure (16) are mutually connected to form a plurality of walls (18) that are intersected with any geometric shape in the cross-section of said panel (10), said plurality of walls (18) enclosing respective prism--shaped channels or cells (20) with bases constituted by a generic closed polygon.

6. Composite structural panel (10) according to claim 1, characterized in that it comprises two or more multiwall-polycarbonate reinforcement structures (16) mutually coupled, with variable thickness and with several extrusion layers.

7. Composite structural panel (10) according to claim 1, characterized in that said multiwall-polycarbonate reinforcement structure (16) is made by a linear or curved honeycomb-polycarbonate panel.

8. Composite structural panel (10) according to claim 1, characterized in that said bonding layer (22) is selected from the group consisting of:
an adhesive;
a heat-sealing process;
a thermal--bonding process;
a double-sided adhesive film.

9. Composite structural panel (10) according to claim 1, characterized in that said bonding layer (22) is obtained by a chemical or thermochemical process of surface deposition of each of said two surfaces (12, 14) directly on e multiwall-polycarbonate reinforcement structure (16).

10. Composite structural panel (10) according to claim 1, characterized in that said bonding layer (22) is obtained by a chemical or thermochemical combined extrusion process of said multiwall-polycarbonate reinforcement structure (16) directly on said two surfaces (12, 14).

11. Composite structural panel (10) according to claim 1, characterized in that also one or more external transversal walls of said panel (10) are at least partially covered with respective laminate sheet having characteristics identical to those of said two surfaces (12, 14).
